(19) United States
(12) Patent Application Publication
(10) Pub. No.: US 2025/0039565 A1
(43) Pub. Date: Jan. 30, 2025

(54) SCAN CONVERSION CONTROLLER, IMAGE PROCESSING CIRCUIT INCLUDING THE SAME, AND METHOD OF OPERATING THE IMAGE PROCESSING CIRCUIT

(71) Applicant: Samsung Electronics Co., Ltd., Suwon-si (KR)

(72) Inventors: Hosuk Han, Suwon-si (KR); Ilho Kim, Suwon-si (KR)

(21) Appl. No.: 18/772,480

(22) Filed: Jul. 15, 2024

(30) Foreign Application Priority Data
Jul. 25, 2023 (KR) 10-2023-0097036

(51) Int. Cl. H04N 25/40; H04N 23/80; H04N 25/42

(52) U.S. Cl. CPC H04N 25/41; H04N 23/80; H04N 25/42

(57) ABSTRACT

An image processing circuit is provided. The image processing circuit includes a scan conversion controller configured to receive images from a plurality of channels connected to a plurality of imaging devices and to generate output data and an image signal processor configured to receive and process the output data from the scan conversion controller. The scan conversion controller is configured to determine a scan method for generating the output data according to a first operation mode or a second operation mode.

### CROSS-REFERENCE TO RELATED APPLICATION

This application is based on and claims priority under 35 U.S.C. § 119 to Korean Patent Application No. 10-2023-0097036, filed on Jul. 25, 2023, in the Korean Intellectual Property Office, the disclosure of which is incorporated by reference herein in its entirety.

### BACKGROUND

The inventive concept relates to a scan conversion controller, an image processing circuit including the same, and a method of operating the image processing circuit.

Due to the development of mobile devices, such as smartphones and tablet personal computer (PCs), electronic devices including a plurality of image sensors are widely used in these types of devices. An image processing apparatus may include an image signal processor that processes an input image generated by a plurality of image sensors.

At this time, to process a plurality of input images provided through a plurality of channels by using one image signal processor, the image signal processor may process a plurality of input images by a time-division multiplexing (TDM) method.

### SUMMARY

An example problem to be solved by the technical idea of the present disclosure is to provide an image processing circuit that supports line interleaving and can easily convert scan methods.

According to an aspect of the inventive concept, there is provided an image processing circuit including a scan conversion controller configured to receive images from a plurality of channels connected to a plurality of imaging devices and to generate output data and an image signal processor configured to receive and process the output data from the scan conversion controller. The scan conversion controller is configured to determine a scan method for generating the output data according to a first operation mode or a second operation mode.

According to another aspect of the inventive concept, there is provided a scan conversion controller including a first data packing circuit configured to receive first line data from a first channel and to pack the first line data into a predetermined data size to generate first packing data, a second data packing circuit configured to receive second line data from a second channel and to pack the second line data into a predetermined data size to generate second packing data, an arbitration circuit configured to receive the first packing data and the second packing data and to sequentially output the first packing data and the second packing data, a memory configured to store the first packing data and the second packing data, a line index controller configured to manage a first index for a first region in which the first packing data is stored in the memory, and a second index for a second region in which the second packing data is stored in the memory, and to determine a scan method of the first packing data and the second packing data allocated to the first index and the second index, respectively, a write controller configured to control a write operation of the memory, a read controller configured to control a read operation of the memory, and an unpacking circuit configured to generate output data by unpacking read data output from the read controller.

According to another aspect of the inventive concept, there is provided a method of operating an image processing circuit including a scan conversion controller including an internal memory, including packing line data received through each of a plurality of channels into a predetermined data size to generate packing data, allocating indices corresponding to each of the plurality of channels and writing the packing data to the internal memory based on addresses included in the allocated indices, managing indices allocated to each of the plurality of channels, determining a scan method of the packing data corresponding to the channel of which input is completed based on indices allocated to one of the plurality of channels to which input of line data is completed, outputting index information corresponding to the determined scan method, reading the packing data from the internal memory based on the index information, and unpacking read data read from the internal memory and generating output data.

### BRIEF DESCRIPTION OF THE DRAWINGS

Embodiments will be more clearly understood from the following detailed description taken in conjunction with the accompanying drawings in which:

FIG. 1 is a block diagram of a data processing system according to an embodiment of the inventive concept;

FIG. 2 is a diagram illustrating an example of the image processing circuit of FIG. 1;

FIGS. 3A and 3B are diagrams illustrating a method of operating a scan conversion controller, according to an embodiment of the inventive concept;

FIGS. 4A and 4B are diagrams illustrating scan conversion methods according to an embodiment of the inventive concept, respectively;

FIGS. 5A and 5B are block diagrams illustrating scan conversion controllers included in image processing circuits according to an embodiment of the inventive concept;

FIG. 6 is a diagram illustrating data processing in a data packing circuit and an arbitration circuit according to an embodiment of the inventive concept;

FIG. 7 is a diagram illustrating a state in which an index is written or read according to an example embodiment of the inventive concept;

FIG. 8 is a diagram illustrating memory of a scan conversion controller according to an embodiment of the inventive concept, and is a diagram illustrating a write operation;

FIG. 9 is a diagram illustrating memory of a scan conversion controller according to an embodiment of the inventive concept, and is a diagram illustrating a read operation;

FIG. 10 is a diagram illustrating index information stored in a plurality of channel index first-in first-out (FIFO) memories according to packing data written to memory according to an embodiment of the inventive concept;

FIG. 11 is a diagram illustrating index information stored in write index FIFO memory according to packing data read from memory according to an embodiment of the inventive concept;

FIGS. 12A to 12C are diagrams illustrating index results output according to a scan operation mode of image data according to an embodiment of the inventive concept;

FIG. 13 is a diagram illustrating a method of outputting a plurality of multi-context data items when the plurality of multi-context data items having different forms are input according to an embodiment of the inventive concept;

FIGS. 14A and 14B are diagrams illustrating an example of storing multi-context data items in a channel index FIFO and reading the multi-context data items in an example method according to an embodiment of the inventive concept; and

FIGS. 15 to 16 are flowcharts illustrating a method of operating an image processing circuit according to an embodiment of the inventive concept.

### DETAILED DESCRIPTION OF THE EMBODIMENTS

Hereinafter, embodiments will be described in detail with reference to the accompanying drawings. Like reference numerals in the drawings denote like elements, and thus their description will be omitted. As used herein, the term “and/or” includes any and all combinations of one or more of the associated listed items. It is noted that aspects described with respect to one embodiment may be incorporated in different embodiments although not specifically described relative thereto. That is, all embodiments and/or features of any embodiments can be combined in any way and/or combination.

The term ‘circuit’ used in embodiments of the inventive concept means a software or hardware component, such as a field programmable gate array (FPGA) or an application specific integrated circuit (ASIC), and the ‘circuit’ is configured to perform certain functions. However, the ‘circuit’ is not limited to software or hardware. The ‘circuit’ may be configured to be in an addressable storage medium and to reproduce one or more processors. Therefore, as an example, the ‘circuit’ may include components such as software components, object-oriented software components, class components, and task components, processes, functions, properties, procedures, subroutines, segments of program code, drivers, firmware, microcode, circuitry, data, databases, data structures, tables, arrays, and variables.

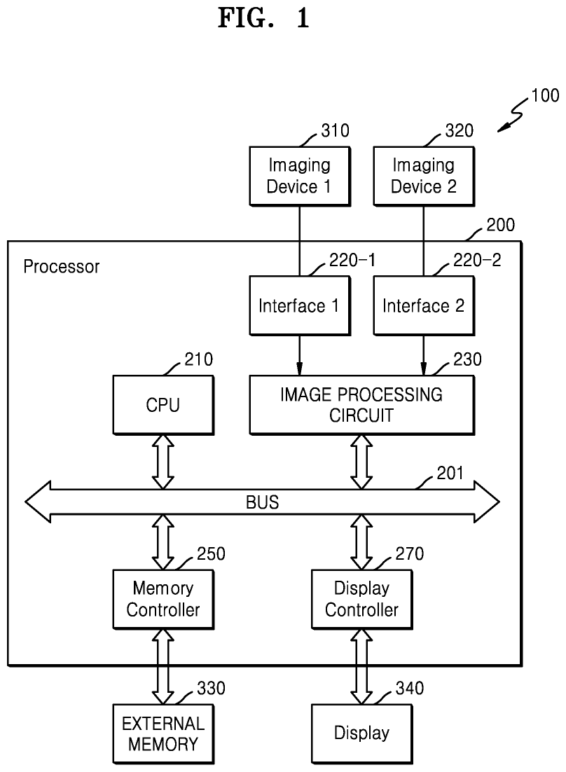

FIG. 1 is a block diagram of a data processing system 100 according to an embodiment of the inventive concept. Referring to FIG. 1, the data processing system 100 may include a processor 200, first and second imaging devices 310 and 320, external memory 330, and a display 340.

The data processing system 100 may be implemented as a personal computer (PC), an Internet of things (IoT) device, and/or a mobile computing device. The mobile computing device may be implemented as a laptop computer, a mobile phone, a smartphone, a tablet PC, a personal digital assistant (PDA), an enterprise digital assistant (EDA), a digital still camera, a digital video camera, a portable multimedia player (PMP), a personal navigation device or portable navigation device (PND), a handheld game console, a mobile internet device (MID), a wearable computer, an IoT device, an Internet of everything (IoE) device, and/or an e-book. In addition, the data processing system 100 may be mounted in electronic devices, such as drones, advanced driver assistance systems (ADAS), or electronic devices provided as parts in vehicles, furniture, manufacturing facilities, doors, and/or various measuring devices. According to an example, the data processing system 100 may be implemented as an electronic device that captures an image, displays the captured image, and/or performs an operation based on the captured image.

The processor 200 may be implemented as an integrated circuit (IC), a motherboard, a system on chip (SoC), an a processor (AP), and/or a mobile AP. However, embodiments of the processor 200 are not limited thereto.

The processor 200 may include a bus structure (or a bus) 201, a central processing unit (CPU) 210, first and second interfaces 220-1 and 220-2, an image processing circuit 230, a memory controller 250, and a display controller 270.

The CPU 210, the image processing circuit 230, the memory controller 250, and the display controller 270 may transmit or receive commands and/or data through the bus structure 201.

The bus structure 201 may be implemented as a bus using an advanced microcontroller bus architecture (AMBA) protocol, a bus using an advanced high-performance bus (AHB) protocol, a bus using an advanced peripheral bus (APB) protocol, a bus using an AMBA extensible interconnect (AXI) protocol, or a combination thereof. However, embodiments of the bus structure 201 are not limited thereto.

The CPU 210 may generally control an operation of the processor 200. For example, the CPU 210 may control the first and second interfaces 220-1 and 220-2, the image processing circuit 230, the memory controller 250, and the display controller 270. The CPU 210 may include one or more cores.

The first interface 220-1 may receive a first image and first control signals output from the first imaging device 310 and may transmit the first image and the first control signals to the image processing circuit 230. The second interface 220-2 may receive a second image and second control signals output from the second imaging device 320 and may transmit the second image and the second control signals to the image processing circuit 230. According to an example, each of the first interface 220-1 and the second interface 220-2 may include a direct memory access (DMA). The first image may mean a first picture, first image data, a first data stream, or first frame data. The second image may mean a second picture, second image data, a second data stream, or second frame data.

The first imaging device 310 may be implemented as a complementary metal oxide semiconductor (CMOS) image sensor chip or a camera module. The first imaging device 310 may transmit the first image and the first control signals to the first interface 220-1 through a mobile industry processor interface (MIPI)® camera serial interface (CSI). The second imaging device 320 may be implemented as a CMOS image sensor chip or a camera module. The second imaging device 320 may transmit the second image and the second control signals to the second interface 220-2 through the MIPI®CSI. For example, when the data processing system 100 includes a dual-camera, the first imaging device 310 may include a rear camera and the second imaging device 320 may include a front camera. For example, resolution of the first image may be different from resolution of the second image.

The first image and the second image respectively output from the first imaging device 310 and the second imaging device 320 may each include a plurality of line data items. According to an embodiment, the first image output from the first imaging device 310 may include a plurality of first line data items. The second image output from the second imaging device 320 may include a plurality of second line data items. The image processing circuit 230 may perform TDM on the first image and/or the second image in units of line data rather than in units of frame data.

For example, the image processing circuit 230 may include a plurality of image signal processor (ISP) cores to process images output from the first imaging device 310 and the second imaging device 320 in units of line data simultaneously, in parallel, or on-the-fly according to a TDM method. Accordingly, the image processing circuit 230 may be implemented as a multi-core ISP.

For example, each of the plurality of ISP cores may perform at least one of automatic dark level compensation, bad pixel replacement, noise reduction, lens shading compensation, color correction, RGB gamma correction, edge enhancement, hue control, and color suppress.

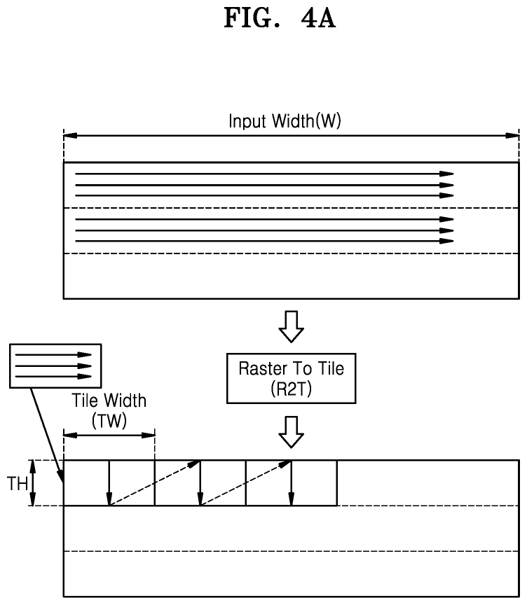

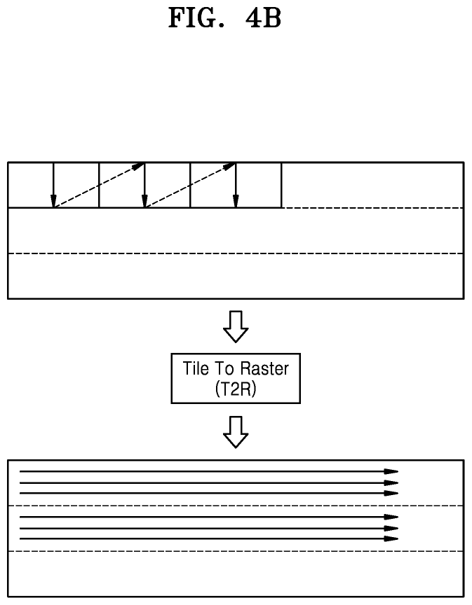

The image processing circuit 230 according to embodiments of the inventive concept may perform line interleaving to process data input first between the first image and the second image, and may be controlled to output the first image and the second image in a desired scan method regardless of which scan method the first image and the second image are input. The image processing circuit 230 according to embodiments of the inventive concept may determine a scan method for generating output data according to a first operation mode or a second operation mode. The image processing circuit 230 according to embodiments of the inventive concept may control the first image and the second image to be scanned in one of the first operation mode and the second operation mode. According to an example, the first operation mode may include a raster scan method and the second operation mode may include a tile scan method. The raster scan method and the tile scan method will be described below with reference to FIGS. 4A and 4B.

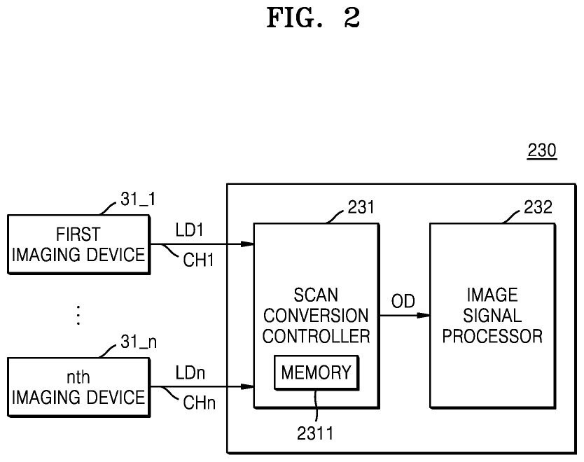

The image processing circuit 230 according to embodiments of the inventive concept may perform scan conversions, such as tile to raster (T2R), raster to tile (R2T), and tile to tile (T2T) by one internal static random access memory (SRAM) when processing multi-context data, that is, various different images. The image processing circuit 230 according to embodiments of the inventive concept will be described in detail below with reference to FIG. 2.

Under control by the CPU 210, the memory controller 250 may store line data processed in units of line data in the external memory 330 by the image processing circuit 230 according to the TDM method.

The display controller 270 may transmit data (for example, frame data) output from the external memory 330 to the display 340 under control by the CPU 210. For example, the display controller 270 may transmit data (for example, frame data) output from the external memory 330 to the display 340 through MIPI® display serial interface (DSI) or embedded displayport (cDP).

Although in FIG. 1 the first and second imaging devices 310 and 320 are illustrated, the number of imaging devices is not limited thereto.

FIG. 2 is a diagram illustrating an example of the image processing circuit 230 of FIG. 1.

Referring to FIG. 2, the image processing circuit 230 may receive a plurality of images. According to an example, the plurality of images received by the image processing circuit 230 may be output from first to nth imaging devices 31_1 to 31_n, respectively. According to an example, each of the first to nth imaging devices 31_1 to 31_n may be implemented as an image sensor chip or a camera module. Each of the first to nth imaging devices 31_1 to 31_n may convert an optical signal reflected from an object into an electrical signal, and may generate and output image data based on the electrical signal.

In an embodiment, one of the first to nth imaging devices 31_1 to 31_n may include, for example, a vertical depth sensor that extracts depth information by using infrared ray (IR). In this case, an imaging device may merge an image data value received from a depth sensor with an image data value received from another image sensor to generate a three-dimensional (3D) depth image.

In an embodiment, at least two image sensors among the first to nth imaging devices 31_1 to 31_n may have different fields of view. In this case, for example, optical lenses of the at least two imaging devices may be different from each other. However, embodiments of the inventive concept are not limited thereto.

Referring to FIG. 2, the image processing circuit 230 may include a scan conversion controller 231 and an image signal processor 232. In an embodiment, the scan conversion controller 231 and the image signal processor 232 may each be included in an AP.

The scan conversion controller 231 may receive a first image from the first imaging device 31_1 and an nth image from the nth imaging device 31_n. For example, the first image may be divided into line data units, and the scan conversion controller 231 may receive first line data LD1 corresponding to the first image through a first channel CH1. The nth image may be divided into line data units, and the scan conversion controller 231 may receive nth line data LDn through an nth channel CHn. In this case, n may be a natural number of 2 or more.

The scan conversion controller 231 may perform TDM in units of line data. The scan conversion controller 231 may transmit output data OD to the image signal processor 232 as a result of performing the TDM.

The scan conversion controller 231 according to embodiments of the inventive concept may perform a first-finish first-out (FFFO) interleaving operation that, in some embodiments, outputs data on a channel on which data input is completed first among first to nth line data items LD1 to LDn without performing a first-in first-out (FIFO) interleaving operation that outputs the first to nth line data items LD1 to LDn provided through first to nth channels CH1 to CHn in the order in which the first to nth line data items LD1 to LDn are input. Therefore, the capacity of memory 2311 in the scan conversion controller 231 may be efficiently used, and the scan conversion controller 231 may be implemented to include a relatively small amount of memory. According to an example, the memory 2311 may include SRAM.

The scan conversion controller 231 according to embodiments of the inventive concept may include the memory 2311 configured to store packing data items obtained by packing images received from the first to nth channels CH1 to CHn according to an index allocated to each channel and a plurality of channel index memories (not shown) configured to store index information of the memory 2311 in which the packing data items are stored by each of the first to nth channels CH1 to CHn. According to an example, channel index memory may operate in a FIFO method. The channel index memory may be referred to as channel index FIFO memory.

When the scan conversion controller 231 according to embodiments of the inventive concept desires to output the first to nth line data items LD1 to LDn, the image signal processor 232 may apply a scan method according to a required format to output the first to nth line data items LD1 to LDn. The scan conversion controller 231 may output the first to nth line data items LD1 to LDn having different formats by using different scan methods. The scan conversion controller 231 may convert a data scan method to output image data by a raster scan method or a tile scan method to match a data format for processing the first to nth line data items LD1 to LDn having different formats by the image signal processor 232. Therefore, it is possible to perform an interleaving operation on a plurality of image data items in the FFFO method and to easily process the plurality of image data items by converting the data scan method to suit characteristics of an image signal processor.

The scan conversion controller 231 may pack the first to nth line data items LD1 to LDn to a constant data size in the memory 2311, and may check an empty space of the memory 2311 to allocate indices to data items arbitrated to interleave the first to nth line data items LD1 to LDn. When data is written to the memory 2311 through the allocated index, the data may be stored in channel index FIFO memories by channel and line and the scan method may be converted and output according to a required data format.

The image signal processor 232 may process the output data OD output from the scan conversion controller 231. In an embodiment, the image signal processor 232 may include a plurality of cores. However, embodiments of the inventive concept are not limited thereto.

For example, the image signal processor 232 may reduce noise with respect to the output data OD output from the first to nth imaging devices 31_1 to 31_n through the scan conversion controller 231, and may perform image signal processing to improve image quality, such as gamma correction, color filter array interpolation, color matrix, color correction, and color enhancement. In addition, image files may be generated by compressing image data generated by image signal processing to improve image quality, or image data may be restored from the image file.

In addition to the aforementioned image processing operation, the image signal processor 232 may perform an operation of converting the format of image data into full image data in red, green, and blue colors.

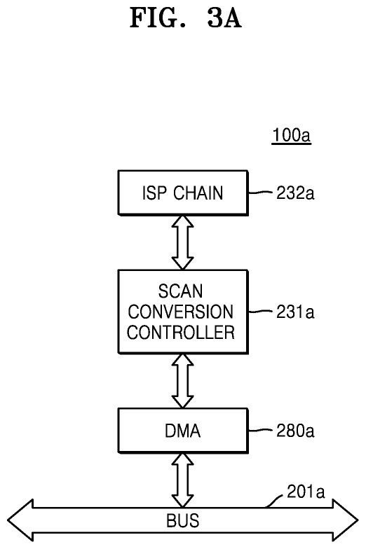

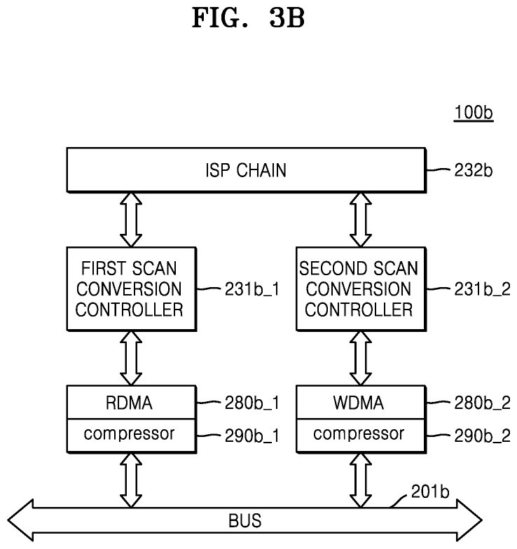

FIGS. 3A and 3B are diagrams illustrating a method of operating a scan conversion controller 231a, according to an embodiment.

Referring to FIG. 3A, a data processing device 100a may include an ISP chain 232a including a plurality of ISP cores, the scan conversion controller 231a, a DMA 280a, and a bus 201a. The ISP chain 232a may correspond to the image signal processor 232 of FIG. 2, the scan conversion controller 231a may correspond to the scan conversion controller 231 of FIG. 2, and the bus 201a may correspond to the bus structure 201 of FIG. 1. Because descriptions of corresponding components are the same, repeated descriptions thereof are omitted.

Referring to FIG. 3A, the DMA 280a may be connected between the scan conversion controller 231a and the bus 201a. The DMA 280a may transmit and receive data to and from a memory device connected to the bus 201a. According to an example, data input to the scan conversion controller 231a may include data input from the imaging device as illustrated in FIG. 2, or data transmitted and received through the DMA 380a.

Referring to FIG. 3B, a data processing device 100b may include an ISP chain 232b including a plurality of ISP cores, a first scan conversion controller 231b_1, a second scan conversion controller 231b_2, a read direct memory access (RDMA) 280b_1, a write direct memory access (WDMA) 280b_2, compressors 290b_1 and 290b_2, and a bus 201b. Because configurations of the ISP chain 232b, the first scan conversion controller 231b_1, the second scan conversion controller 231b_2, and the bus 201b included in the data processing device 100b of FIG. 3B are the same as those described with reference to FIG. 3A, repeated descriptions thereof are omitted.

According to an example, the RDMA 280b_1 and the compressor 290b_1 may be connected between the first scan conversion controller 231b_1 and the bus 201b. The RDMA 280b_1 may read data stored in an external memory device and may directly transmit the data to internal memory provided in the first scan conversion controller 231b_1. The compressor 290b_1 may compress the data transmitted through the RDMA 280b_1 at a constant ratio.

According to an example, the first scan conversion controller 231b_1 may convert a scan method into a T2R method. For example, in the ISP chain 232b, when processing is to be performed in the raster scan method, the compressor 290b_1 may compress the data received through the bus 201b in the tile scan method, and the data compressed through the RDMA 280b_1 may be received by the first scan conversion controller 231b_1. The first scan conversion controller 231b_1 may convert the received tile-type data into raster scan-type data.

According to an example, the WDMA 280b_2 and the compressor 290b_2 may be connected between the second scan conversion controller 231b_2 and the bus 201b. The WDMA 280b_2 may directly transmit the data stored in the internal memory of the second scan conversion controller 231b_2 to the external memory device and may write the data in the external memory device. The compressor 290b_2 may compress the data transmitted through the WDMA 280b_2 at a constant ratio. According to an example, the second scan conversion controller 231b_2 may convert a scan method into a R2T method. According to an example, in the ISP chain 232b, when data is to be processed in the raster scan method, the second scan conversion controller 231b_2 may receive the data processed in the raster scan method, may convert the data into tile-type data, and may transmit the tile-type data to the WDMA 280b_2. The data transmitted to the WDMA 280b_2 may be processed through the compressor 290b_2 and transmitted to the bus 201b.

Referring to FIGS. 3A and 3B, in the ISP chains 232a and 232b, when processing is to be performed in the raster scan method or the tile scan method, a T2R or R2T conversion module may be required according to the type of input data. According to an example, the scan conversion controllers 231a, 231b_1, and 231b_2 according to the inventive concept may be applied to tile-based processing in cases, such as a neural network (NN), a local motion (LM), and a compressor.

A scan conversion controller according to embodiments of the inventive concept may support multi-context data processing in the same area and may function as a line interleaving controller and a throttle buffer. According to an example, the role of the line interleaving controller may be performed by the scan conversion controller connected to the RDMA, and the role of the throttle buffer may be performed by the scan conversion controller connected to the WDMA. According to an example, a compressor may compress data in units of tiles.

A high bandwidth (BW) is required to store images obtained by a plurality of image devices in memory in order to utilize the images in various ways. However, because a BW of a bus for communication is limited, it is necessary to reduce a BW of an image to be stored by a compressor. Because compressing a tiled image has a much higher compression rate than compressing an image processed by a raster scan method, tile processing may be desirable to increase the compression rate of the compressor. According to a comparative example, because a high BW is desired, processing at a limited BW may not be performed according to a bus configuration. However, in the case of the scan conversion controller according to embodiments of the inventive concept, although a plurality of images are input at the same time, the plurality of images may be processed by using one module without using modules corresponding one-to-one to the plurality of images. Therefore, it may be effective in terms of reduction in area and it is possible to reduce the number of WDMAs. In addition, power may be reduced by reducing the area.

FIGS. 4A and 4B are diagrams illustrating scan conversion methods according to an embodiment of the inventive concept, respectively.

The raster scan method may mean sequentially scanning image data by line. Referring to FIG. 4A, when the total width of input image data is W, by using the raster scan method, first line data is read as much as W, which is the total width, and then second line data is read as W continuously so that the image data may be scanned.

The tile scan method may mean setting a tile region having a certain region smaller than the image data and sequentially scanning each line within the tile region. Referring to FIG. 4A, a width of the set tile region may be a tile width (TW), and a height of the tile region may be a tile height (TH). By using the tile scan method, the image data may be scanned by reading the first line data as much as TW, the width of the tile region, and then reading the second line data as much as TW repeatedly up to the line corresponding to the TH, the height of the tile region.

In this disclosure, “raster scan method” and “raster scan mode” may be described with the same meaning, and “tile scan method” and “tile scan mode” may also be described with the same meaning.

FIG. 4A illustrates an example of converting from the raster scan method to the tile scan method. FIG. 4B illustrates an example of converting from the tile scan method to the raster scan method. As described above, it is illustrated that the data scan method may be converted according to a method to be processed although the same image data is scanned. According to an example of the present invention, R2T and T2R illustrated in FIGS. 4A and 4B may correspond to the scan conversion controller according to the inventive concept. In addition, although only R2T or T2R is described with reference to FIG. 4A, it should be noted that a T2T method, which is conversion between different tile regions, may also be performed by the scan conversion controller.

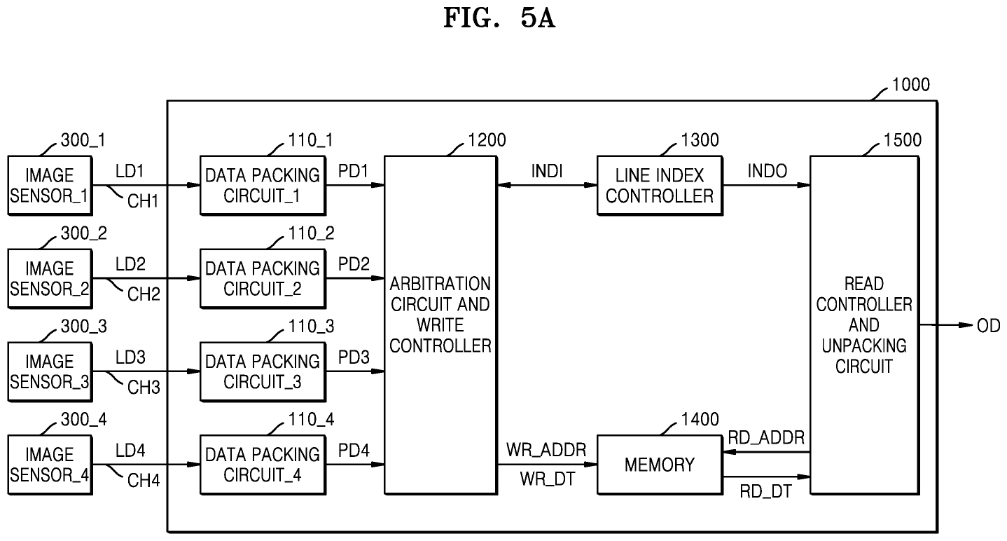

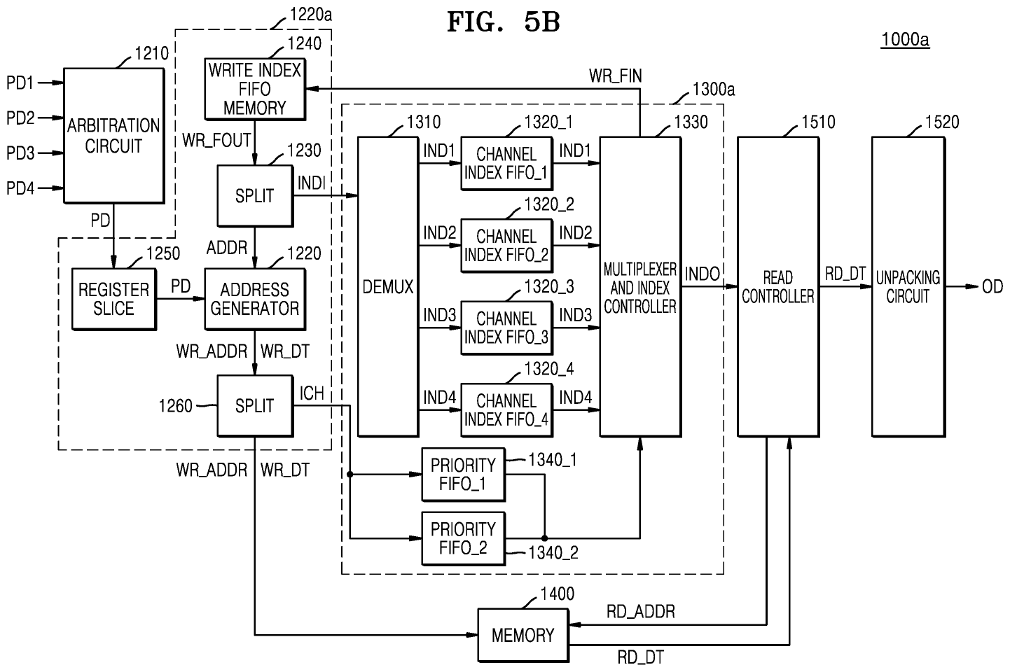

FIGS. 5A and 5B are block diagrams illustrating scan conversion controllers 1000 and 1000a included in image processing circuits according to an embodiment. It is illustrated in FIG. 5A that the scan conversion controller 1000 receives image data from four (that is, n=4) image sensors. However, the scan conversion controller according to embodiments of the inventive concept are not limited thereto, and n may have various values.

Referring to FIG. 5A, the scan conversion controller 1000 may include a plurality of data packing circuits (for example, first to fourth packing circuits 110_1 to 110_4), an arbitration circuit and write controller 1200, a line index controller 1300, memory 1400, and a read controller and unpacking circuit 1500. The scan conversion controller 1000 may receive first to fourth line data items LD1 to LD4 from first to fourth image sensors 300_1 to 300_4 through first to fourth channels CH1 to CH4, respectively.

The first data packing circuit 110_1 may receive the first line data LD1 from the first channel CH1 and may pack the first line data LD1 to a predetermined data size to generate first packing data PD1. The second data packing circuit 110_2 may receive the second line data LD2 from the second channel CH2 and may pack the second line data LD2 to a predetermined data size to generate second packing data PD2. The third data packing circuit 110_3 may receive the third line data LD3 from the third channel CH3 and may pack the third line data LD3 to a predetermined data size to generate third packing data PD3. The fourth data packing circuit 110_4 may receive the fourth line data LD4 from the fourth channel CH4 and may pack the fourth line data LD4 to a predetermined data size to generate fourth packing data PD4.

In an embodiment, a predetermined data size of packing data, which is a packing unit of the packing operation, may be determined according to at least one of the number of channels connected to the scan conversion controller 1000, the maximum number of bits received during a clock signal cycle in line data received from a plurality of channels, and the number of pixels per clock signal cycle (PPC) of line data. For example, the data size of the packing data may be determined by multiplying the number of channels connected to the scan conversion controller 1000, the maximum number of bits received during a clock signal cycle from different line data items received from the plurality of channels, and the number of PPCs of the line data.

The arbitration circuit and write controller 1200 may include an arbitration circuit receiving the first to fourth packing data items PD1 to PD4 from the first to fourth data packing circuits 110_1 to 110_4 and sequentially outputting the first to fourth packing data items PD1 to PD4 as packing data items and a write controller controlling a write operation of the memory 1400. Because the arbitration circuit performs arbitration on the first to fourth packing data items PD1 to PD4, which are packed data items, although any data among the first to fourth packing data items PD1 to PD4 is selected to be output as packing data, the data may be selected and output only once per at least 4 cycles of a clock signal. That is, although the first to fourth line data items LD1 to LD4 are continuously input from the first to fourth channels CH1 to CH4, the arbitration circuit may arbitrate the first to fourth packing data items PD1 to PD4 although there is no separate storage of the first to fourth packing data items PD1 to PD4.

The write controller may receive packing data from the arbitration circuit and may store (write) the packing data in the memory 1400. The write controller may allocate an index according to a channel corresponding to packing data and may transmit index information INDI according to the allocated index to the line index controller 1300. The write controller may convert the allocated index into a plurality of write addresses WR_ADDR and may transmit packing data to the memory 1400 as write data WR_DT. Accordingly, the first to fourth packing data items PD1 to PD4 may be sequentially provided to the memory 1400 as the write data WR_DT. In an embodiment, a data size corresponding to one index may be a multiple of, for example, 8 times or 16 times the data size of the packing data.

The line index controller 1300 may manage a plurality of channels, that is, indices corresponding to the first to fourth channels CH1 to CH4. For example, the line index controller 1300 may include first to fourth memories storing index information items corresponding to the first to fourth channels CH1 to CH4, and may store the index information INDI in corresponding memory among the first to fourth memories according to the index information INDI received from the arbitration circuit and write controller 1200. The line index controller 1300 may determine a scan method of any one of the first to fourth memories storing the index information items corresponding to the first to fourth channels CH1 to CH4.

In addition, the line index controller 1300 may provide index information INDO on indices to be read to the read controller and unpacking circuit 1500 to perform a read operation on the memory 1400. That is, index information INDO on indices corresponding to a channel on which image data input is completed among the first to fourth channels CH1 to CH4 may be provided to the read controller and unpacking circuit 1500.

When transmitting the index information INDO on the indices to be read, the line index controller 1300 may transmit the index information INDO by applying a scan method corresponding to an image processing method in an image processing circuit. According to an example, the line index controller 1300 may transmit the index information INDO to read the indices in the raster scan method or the tile scan method.

For example, the memory 1400 may include, for example, SRAM. However, in other embodiments, the memory 1400 may be implemented as another type of memory. The memory 1400 may store (write) packing data in a memory region according to an allocated index according to the plurality of write addresses WR_ADDR and the write data DT provided by the arbitration circuit and write controller 1200.

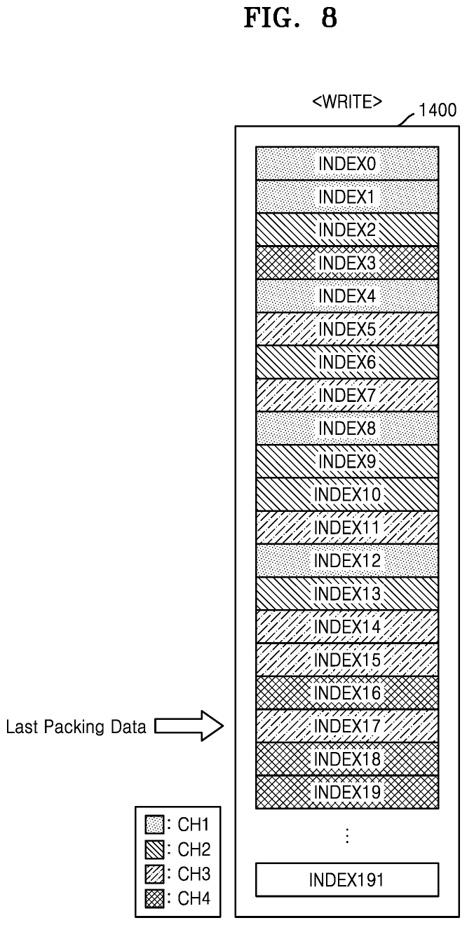

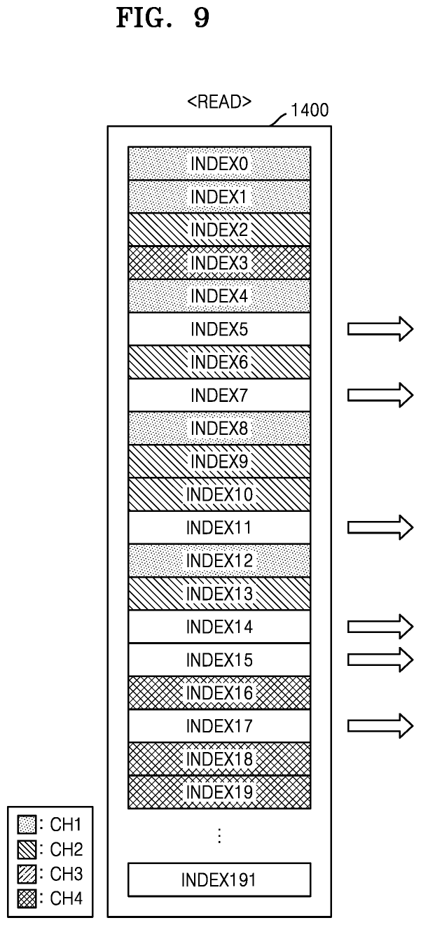

In addition, the memory 1400 may output (read) read data RD_DT according to a plurality of read addresses RD_ADDR provided by the read controller and unpacking circuit 1500. The plurality of read addresses RD_ADDR may correspond to specific indices, and packing data items of a channel corresponding to the specific indices may be read as the read data RD_DT. Description of the write operation and the read operation of the memory 1400 will be given below with reference to FIGS. 8 to 9.

The read controller and unpacking circuit 1500 may include a read controller that controls the read operation of the memory 1400, and an unpacking circuit that outputs the output data OD by unpacking the read data RD_DT output from the read controller. The unpacking circuit may unpack the output data OD to have the same data form as each of the first to fourth line data items LD1 to LD4.

The read controller may provide the plurality of read addresses RD_ADDR to the memory 1400 and may receive the read data RD_DT from the memory 1400. The read controller may receive the index information INDO on the indices to be read, that is, corresponding to the channel on which the image data input is completed among the first to fourth channels CH1 to CH4 from the line index controller 1300 and may generate the plurality of read addresses RD_ADDR based on the index information INDO. Accordingly, the read controller may not read the read data RD_DT from the memory 140 in the order in which the read data RD_DT is input first from the first to fourth line data items LD1 to LD4 provided through the first to fourth channels CH1 to CH4, and may read the read data RD_DT for the channel through which the image data input is completed first from among the first to fourth channels CH1 to CH4 based on the index information INDO.

The scan conversion controller 1000 according to embodiments of the inventive concept does not output the first to nth line data items LD1 to LDn provided through the first to nth channels CH1 to CHn as output data OD in the order input first. In the controller of the comparative example in which the interleaving operation is performed in a first-in-first-out manner, when the speed of the first image sensor 300_1 is low and the speed of the second image sensor 300_2 is high, when the first line data LD1 is first received from the first image sensor 300_1, although a large amount of the second line data LD2 is provided from the second image sensor 300_2, the second line data LD2 accumulates in the memory of the scan conversion controller of the comparative example until the first line data LD1 of the first image sensor 300_1 is output as output data. Therefore, a throughput of the scan conversion controller in a comparative example is reduced and the memory becomes full.

On the other hand, according to embodiments of the inventive concept, the scan conversion controller 1000 does not perform an interleaving operation in the FIFO manner and performs a FFFO interleaving operation in which image data for a channel on which image data input is completed first among the first to fourth image data items is output first. In addition, the scan conversion controller 1000 may convert the output data OD to scan the image data in a desired method by transmitting the index information INDO to the read controller differently depending on the method used for the image data scan. Accordingly, the processing rate of the scan conversion controller 1000 is improved, and the memory 1400 may be efficiently used.

FIG. 5B is a block diagram for configuring a scan conversion controller 1000a according to an embodiment. The scan conversion controller 1000a of FIG. 5B is an example of the scan conversion controller of FIG. 5A. In FIG. 5B, descriptions as those of FIG. 5A are omitted for the same reference numerals as those in FIG. 5A.

Referring to FIGS. 5A and 5B, the scan conversion controller 1000a may include an arbitration circuit 1210, a write controller 1220a, a line index controller 1300a, memory 1400, a read controller 1510, and an unpacking circuit 1520. Although not shown in FIG. 5B, the scan conversion controller 1000a may further include a plurality of data packing circuits.

The arbitration circuit 1210 may receive the first to fourth packing data items PD1 to PD4 and may sequentially output the first to fourth packing data items PD1 to PD4 as packing data PD. When two or more of the first to fourth packing data items PD1 to PD4 are simultaneously received, the arbitration circuit 1210 may select the received packing data items one-by-one and may sequentially output the packing data items.

The write controller 1220a may include an address generator 1220, split circuits 1230 and 1260, a write index FIFO memory 1240, and a register slice circuit 1250. The register slice circuit 1250 may receive the packing data PD from the arbitration circuit 1210 and may transmit the packing data to the address generator 1220.

The split circuit 1260 may receive the plurality of write addresses WR_ADDR and the write data WR_DT from the address generator 1220 and may output channel information ICH on a channel through which image data is transmitted to the line index controller 1300a when the write data WR_DT is the last packing data of the image data. That is, channel information ICH on a channel on which line data input is completed may be output. The split circuit 1260 may transmit the plurality of write addresses WR_ADDR and the write data WR_DT to the memory 1400.

The split circuit 1230 may receive write index information WR_FOUT including empty index information and may provide the index information INDI on an index in which the packing data PD is to be stored to the line index controller 1300a based on the write index information WR_FOUT. The split circuit 1230 may generate addresses ADDR corresponding to index information IND, based on the write index information WR_FOUT.

The write index FIFO memory 1240 may store index information on indices according to a region in which a data write operation may be performed, that is, empty index information in the memory 1400. The write index FIFO memory 1240 may receive index information WR_FIN on indices on which a read operation is performed from the read controller 1510 and may update the empty index information. That is, the write index FIFO memory 1240 may be updated when performing a write operation on the memory 1400 and when performing a read operation on the memory 1400.

The line index controller 1300a may include a demultiplexer 1310, a plurality of channel index FIFO memories (for example, first to fourth channel index FIFO memories 1320_1 to 1320_4), and a multiplexer and index controller 1330. The demultiplexer 1310 may receive the index information INDI from the write controller 1220a and may transmit the index information INDI to one of the first to fourth channel index FIFO memories 1320_1 to 1320_4. For example, when the index information INDI corresponds to the first channel CH1, the index information INDI may be provided to the first channel index FIFO memory 1320_1 as first index information IND1. Alternatively, for example, when the index information INDI corresponds to one of the second to fourth channels CH2 to CH4, one of second to fourth index information items IND2 to IND4 may be provided to corresponding channel index FIFO memory among the second to fourth channel index FIFO memories 1320_2 to 1320_4. Each of the first to fourth index information items IND1 to IND4 may include index information on a region in which packing data according to a corresponding channel among the first to fourth channels CH1 to CH4 is written to the memory 1400.

According to embodiments of the inventive concept, the channel index FIFO memory may be a channel index memory that operates in the FIFO method. According to embodiment of the inventive concept, the channel index memory included in the line index controller 1300a is referred to as channel index FIFO memory on the premise that the channel index memory operates in the FIFO method. However, embodiments of the inventive concept are not limited thereto. According to embodiments of the inventive concept, the channel index memory included in the line index controller 1300a may not operate in the FIFO method. According to embodiments of the inventive concept, for convenience, the channel index memory included in the line index controller 1300a is referred to as channel index FIFO memory.

The number of channel index FIFO memories included in the line index controller 1300a may be the same as the number of channels connected to the scan conversion controller 1000a. When the number of channels connected to the scan conversion controller 1000a changes, the number of channel index FIFO memories included in the line index controller 1300a may also change. The first channel index FIFO memory 1320_1 may store index information of the memory 1400 in which the first packing data PD1 received from the first channel CH1 is stored, the second channel index FIFO memory 1320_2 may store index information of the memory 1400 in which the second packing data PD2 received from the second channel CH2 is stored, the third channel index FIFO memory 1320_3 may store index information of the memory 1400 in which the third packing data PD3 received from the third channel CH3 is stored, and the fourth channel index FIFO memory 1320_4 may store index information of the memory 1400 in which the fourth packing data PD4 received from the fourth channel CH4 is stored. That is, information on indices allocated to the first to fourth channels CH1 to CH4 may be stored in the first to fourth channel index FIFO memories 1320_1 to 1320_4, respectively.

The multiplexer and index controller 1330 may receive the first to fourth index information items IND1 to IND4 from the first to fourth channel index FIFO memories 1320_1 to 1320_4. The multiplexer and index controller 1330 may provide index information INDO on indices corresponding to the channel on which image data input is completed among the first to fourth channels CH1 to CH4 to the read controller 1510. For example, when the image data input is completed on the third channel CH3, the multiplexer and index controller 1330 may provide the third index information IND3 received from the third channel index FIFO memory 1320_3 to the read controller 1510 as the index information INDO.

The multiplexer and index controller 1330 may output the index information INDO for a read operation based on information stored in the channel index FIFO memory corresponding to the channel of packing data of which input is completed first among the packing data items.

According to an example, in the first operation mode, the multiplexer and index controller 1330 may output index information INDO so that indices stored in the channel index FIFO memory corresponding to the channel of packing data of which input is completed first among packing data items are sequentially read from the first line for as much as an entire width of the channel index FIFO memory.

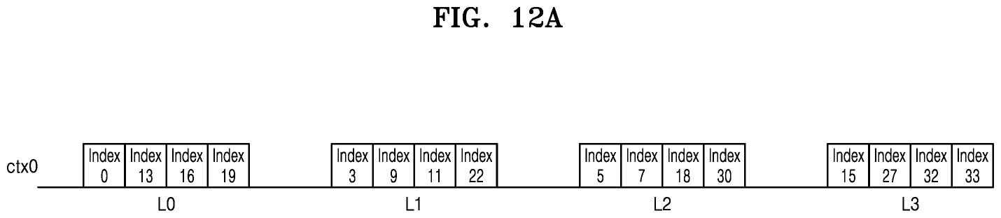

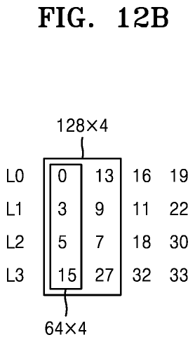

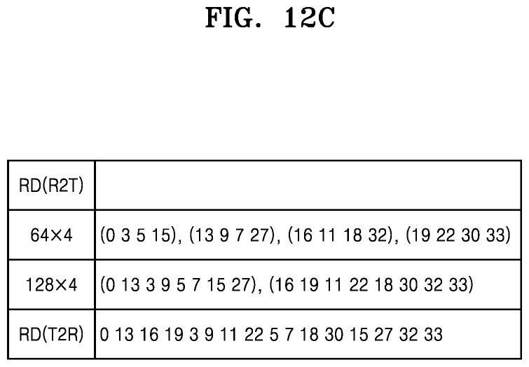

According to an example, in the second operation mode, the multiplexer and index controller 1330 may output index information INDO by sequentially reading indices stored in the channel index FIFO memory corresponding to the channel of packing data of which input is completed first among packing data items from the first line for as much as a width of a set tile region as many lines as the number corresponding to a height of the set tile region, of which specific examples will be described below with reference to FIGS. 12A to 12C.

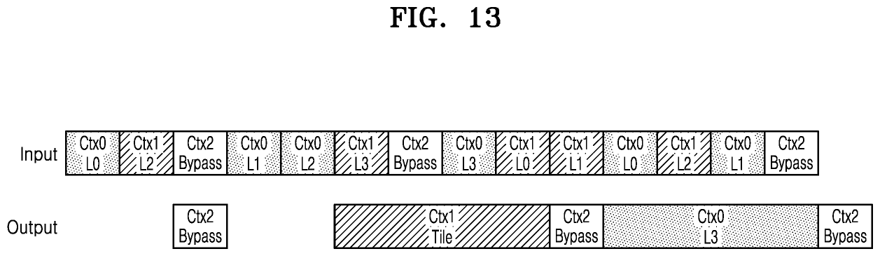

According to an example, when a plurality of packing data items are randomly input, the multiplexer and index controller 1330 may immediately output index information when it is not required to convert a scan method of input index information and there is no packing data input that is completed first, and may output the obtained index information after outputting the packing data when the packing data input is completed first, of which specific examples will be described below with reference to FIG. 13.

The multiplexer and index controller 1330 may transmit index information WR_FIN on indices on which the read operation is performed to the write controller 1220a. The index information WR_FIN on the indices on which the read operation is performed may include the same information as the index information INDO on the indices corresponding to the channel on which the image data input is completed. For example, in the multiplexer and index controller 1330, indices from which data is written in the memory 1400 may be displayed as ‘1’, and indices from which data is read from the memory 1400 (for example, empty indices) may be displayed as ‘0’ to be stored.

The line index controller 1300a may include at least one priority memory for storing priority information on the plurality of channels (for example, the first to fourth channels CH1 to CH4) according to channel information ICH received from the write controller 1220a. For example, the line index controller 1300a may include first priority FIFO memory 1340_1 and second priority FIFO memory 1340_2. The first priority FIFO memory 1340_1 may store information on a channel having a relatively high data processing priority, and the second priority FIFO memory 1340_2 may store information on a channel having a relatively low data processing priority. Although only the first priority FIFO memory 1340_1 and the second priority FIFO memory 1340_2 are illustrated in FIG. 5B, the embodiments of inventive concept are not limited thereto, and the line index controller 1300a may include one priority FIFO memory or three or more priority FIFO memories.

For example, line data input may be completed for both the third channel CH3 and the second channel CH2, and in this case, the processing priority of the third channel CH3 may be higher than the processing priority of the second channel CH2. Information on the third channel CH3 may be stored in the first priority FIFO memory 1340_1 according to the channel information ICH of the third channel CH3, and information on the second channel CH2 may be stored in the second priority FIFO memory 1340_2 according to the channel information ICH of the second channel CH2.

The multiplexer and index controller 1330 may provide index information INDO to the read controller 1510 to read packing data for a channel corresponding to the first priority FIFO memory 1340_1 in preference to packing data for a channel corresponding to the second priority FIFO memory 1340_2. For example, when information on the third channel CH3 is stored in the first priority FIFO memory 1340_1 and information on the second channel CH2 is stored in the second priority FIFO memory 1340_2, the index information INDO may be provided to the read controller 1510 to read packing data for the second channel CH2 from the memory 1400 in preference to packing data for the third channel CH3. Accordingly, the scan conversion controller 1000a may output the output data OD corresponding to the third line data provided through the third channel CH3, and then may output the output data OD corresponding to the third line data provided through the second channel CH2.

The read controller 1510 may provide read addresses RD_ADDR to the memory 1400 based on the index information INDO and may receive read data RD_DT from the memory 1400. The unpacking circuit 1520 may unpack the read data RD_DT and output as the output data OD so that the output data OD has the same data format as each of the first to fourth line data LD1 to LD4.

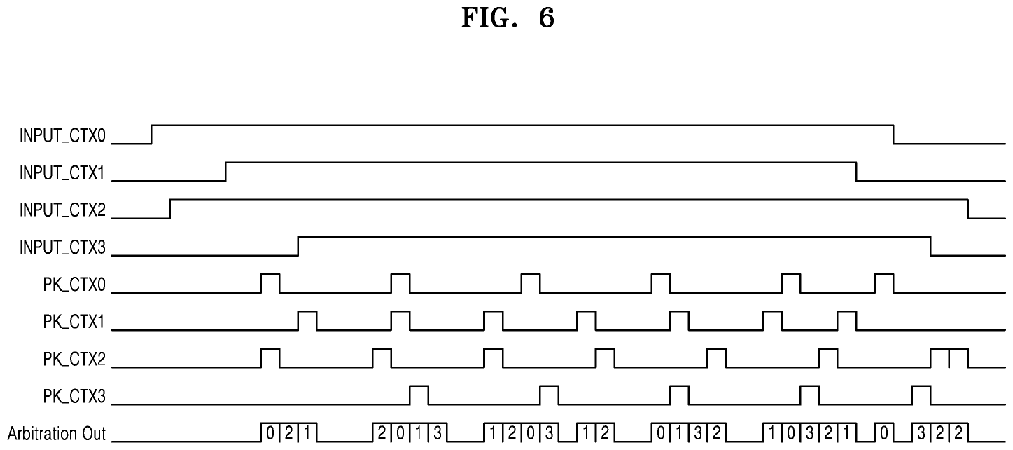

FIG. 6 is a diagram illustrating data processing in a data packing circuit and an arbitration circuit according to embodiments of the inventive concept.

FIG. 6 illustrates four different input data items, a result of packing the four different input data items, and a result of arbitrating the packed data items in order.

Four different input data items INPUT_CTX0, INPUT_CTX1, INPUT_CTX2, and INPUT_CTX3 in FIG. 6 may mean input data items input to the scan conversion controller through different channels. According to an example, the input data items INPUT_CTX0, INPUT_CTX1, INPUT_CTX2, and INPUT_CTX3 may be line data items input through different channels. The different input data items INPUT_CTX0, INPUT_CTX1, INPUT_CTX2, and INPUT_CTX3 may be input according to a cycle of a clock signal toggling to have a specific period. The different input data items INPUT_CTX0, INPUT_CTX1, INPUT_CTX2, and INPUT_CTX3 may have different sizes.

The different input data items INPUT_CTX0, INPUT_CTX1, INPUT_CTX2, and INPUT_CTX3 may be packed into a predetermined size through the data packing circuit. In an embodiment, data sizes of first to fourth packed packing data items PK_CTX0, PK_CTX1, PK_CTX2, and PK_CTX3 may be determined by multiplying the number of channels connected to the scan conversion controller, the maximum number of bits received during one clock signal cycle from different line data items received by the plurality of channels, and the number of pixels per clock signal cycle of line data with one another.

Referring to FIG. 6, output timing and output intervals of the first packing data PK_CTX0, the second packing data PK_CTX1, the third packing data PK_CTX2, and the fourth packing data PX_CTX3 may be the same or different. The first packing data PK_CTX0, the second packing data PK_CTX1, the third packing data PK_CTX2, and the fourth packing data PX_CTX3 may include information on the corresponding input data items INPUT_CTX0, INPUT_CTX1, INPUT_CTX2, and INPUT_CTX3.

The arbitration circuit may arbitrate the first packing data PK_CTX0, the second packing data PK_CTX1, the third packing data PK_CTX2, and the fourth packing data PX_CTX3 at each point in time of output, and may control the first packing data PK_CTX0, the second packing data PK_CTX1, the third packing data PK_CTX2, and the fourth packing data PX_CTX3 to be sequentially output.

Referring to output data Arbitration Out of the arbitration circuit of FIG. 6, 0 means the first packing data PK_CTX0, 1 means the second packing data PK_CTX1, 2 means the third packing data PK_CTX2, and 3 means the fourth packing data PX_CTX3. The first packing data PK_CTX0 and the third packing data PK_CTX2 output at the same time may be sequentially output, and the second packing data PK_CTX1 output thereafter may be sequentially output. Accordingly, 0, 2, and 1 may be sequentially output. Next, the third packing data PK_CTX2 may be output first, the first packing data PK_CTX0 and the second packing data PK_CTX1 may be output at the same time, and then the fourth packing data PK_CTX3 may be output. Accordingly, 2, 0, 1, and 3 may be sequentially output.

Referring to FIG. 6, when data items are input through different channels, the data items may be packed through data packing, and the packed data items may be sequentially output through an arbitration circuit to be arbitrated. Packed data items may be addressed by channel. According to an example, one index may include a plurality of addresses.

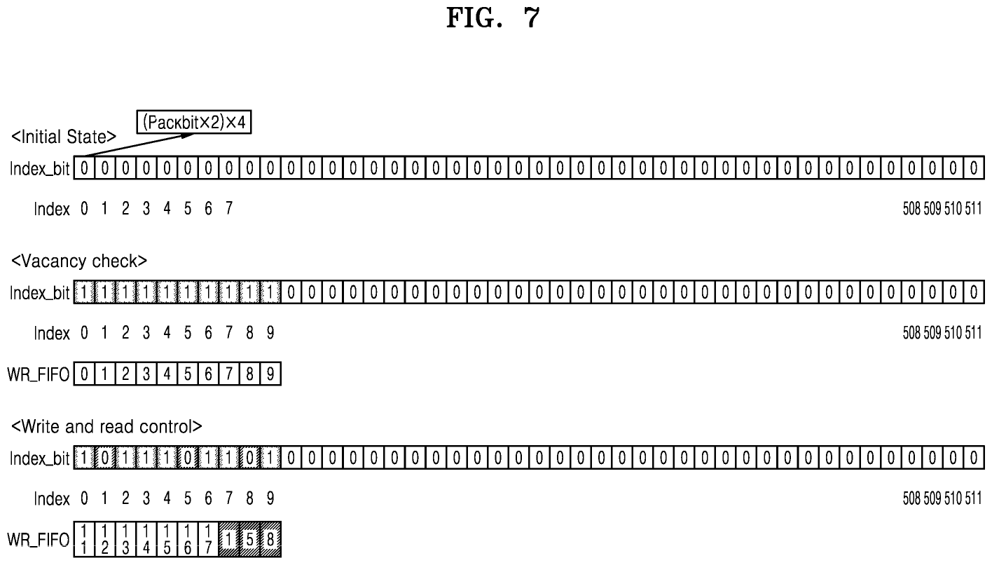

FIG. 7 is a diagram illustrating a state in which an index is written or read according to an example embodiment of the inventive concept. Referring to FIG. 7, an index of an initial state and an index state when an empty index is checked, written, or read is illustrated.

The index allocation of FIG. 7 may be performed by the write controller 1220a of FIG. 5B. Referring to FIGS. 5B and 7, to allocate an index to memory, an empty space of the index may be checked and stored in the write index FIFO memory 1240. At this time, an empty index may be indicated as “0”, and an index on which writing is performed to be filled may be indicated as “1”. In addition, an index that has already been read may be indicated as “O” again.

In the initial state of FIG. 7, all indices may be empty. Therefore, all corresponding bits are indicated as 0. According to an example, the size of data corresponding to one index may be a constant multiple of the size of packing data.

When checking the empty indices of FIG. 7, bits corresponding to indices 0 to 9 are changed to 1 and bits of the remaining indices are 0. In this case, write index FIFO memory WR_FIFO may store information on indices of which bits are changed to 1 and information on indices of which bits remain at 0.

In an example of index allocation for performing writing or reading in FIG. 7, bits of indices (index 1, index 5, and index 8) for which reading has been completed are changed to 0. That is, for indices for which reading has been completed, the bits are changed from 1 to 0 again to become empty indices, which may be stored in the write index FIFO memory WR_FIFO.

Referring to FIG. 7, it is illustrated that, to allocate data items arbitrated by the arbitration circuit, an empty space of an index is checked and an index space for writing may be secured after the index is updated to reflect the checking. Through FIG. 7, it may be determined where an index to be written is and which index is to be read.

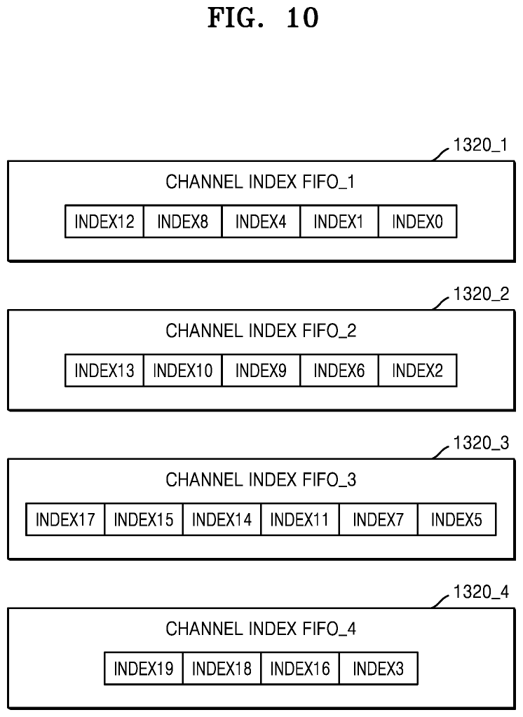

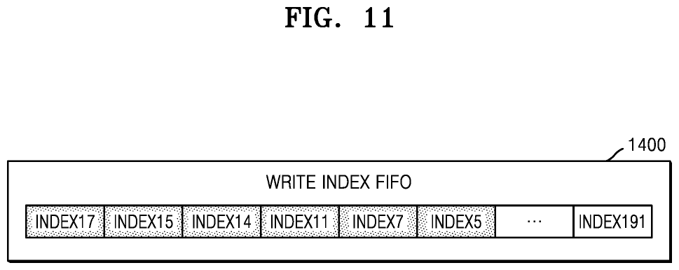

FIG. 8 is a diagram illustrating memory 1400 of a scan conversion controller according to an embodiment of the inventive concept, and is a diagram illustrating a write operation. FIG. 9 is a diagram illustrating memory 1400 of a scan conversion controller according to an embodiment of the inventive concept, and is a diagram illustrating a read operation. FIG. 10 is a diagram illustrating index information stored in a plurality of channel index FIFO memories according to packing data written to memory. FIG. 11 is a diagram illustrating index information stored in write index FIFO memory according to packing data read from memory.

Referring to FIGS. 8 to 10, a region of the memory 1400 may be divided into a plurality of indices. For example, 192 indices (for example, INDEX0 to INDEX191) may be designated for the memory 1400. However, embodiments of the inventive concept are not limited thereto. At this time, a data size of an index may be a multiple of, for example, 8 times or 16 times a data size of packing data. For example, when the data size of the packing data is 448 bits, the data size of the index may be 3584 bits, which is 8 times the data size of 448 bits.

The first, second, fifth, ninth, and thirteenth indices INDEX0, INDEX1, INDEX4, INDEX8, and INDEX12 may be allocated to the first channel CH1. That is, the first packing data PD1 in which the first line data LD1 provided by the first channel CH1 is packed may be stored in regions indicated by the first, second, fifth, ninth, and thirteenth indices INDEX0, INDEX1, INDEX4, INDEX8, and INDEX12. Therefore, index information on the first, second, fifth, ninth, and thirteenth indices INDEX0, INDEX1, INDEX4, INDEX8, and INDEX12 may be stored in first channel index FIFO memory 1320_1.

The third, seventh, tenth, eleventh, and fourteenth indices INDEX2, INDEX6, INDEX9, INDEX10, and INDEX13 may be allocated to the second channel CH2. That is, the second packing data PD2 in which the second line data LD2 provided by the second channel CH2 is packed may be stored in regions indicated by the third, seventh, tenth, eleventh, and fourteenth indices INDEX2, INDEX6, INDEX9, INDEX10, and INDEX13. Therefore, index information on the third, seventh, tenth, eleventh, and fourteenth indices INDEX2, INDEX6, INDEX9, INDEX10, and INDEX13 may be stored in second channel index FIFO memory 1320_2.

The sixth, eighth, twelfth, fifteenth, sixteenth, and eighteenth indices INDEX5, INDEX7, INDEX11, INDEX14, INDEX15, and INDEX17 may be allocated to the third channel CH3. That is, the third packing data PD3 in which the third line data LD3 provided by the third channel CH3 is packed may be stored in regions indicated by the sixth, eighth, twelfth, fifteenth, sixteenth, and eighteenth indices INDEX5, INDEX7, INDEX11, INDEX14, INDEX15, and INDEX17. Therefore, index information on the sixth, eighth, twelfth, fifteenth, sixteenth, and eighteenth indices INDEX5, INDEX7, INDEX11, INDEX14, INDEX15, and INDEX17 may be stored in third channel index FIFO memory 1320_3.

The fourth, seventeenth, nineteenth, and twentieth indices INDEX3, INDEX16, INDEX18, and INDEX19 may be allocated to the fourth channel CH4. That is, the fourth packing data PD4 in which the fourth line data LD4 provided by the fourth channel CH4 is packed may be stored in regions indicated by the fourth, seventeenth, nineteenth, and twentieth indices INDEX3, INDEX16, INDEX18, and INDEX19. Therefore, index information on the fourth, seventeenth, nineteenth, and twentieth indices INDEX3, INDEX16, INDEX18, and INDEX19 may be stored in fourth channel index FIFO memory 1320_4.

At this time, image data input from the third channel CH3 may be first completed. The third packing data PD3 written in the eighteenth index INDEX17 may be the last packing data. Accordingly, all of the third packing data PD3 corresponding to the third channel CH3 may be read from the memory 1400.

Referring to FIGS. 8 to 11, image data input from the third channel CH3 among the first to fourth channels CH1 to CH4 may be completed first. The third packing data PD3 written in the eighteenth index INDEX17 may be the last packing data, and all of the third packing data PD3 corresponding to the third channel CH3 may be read from the regions indicated by the sixth, eighth, twelfth, fifteenth, sixteenth, and eighteenth indices INDEX5, INDEX7, INDEX11, INDEX14, INDEX15, and INDEX17 of the memory 1400.

Because new packing data may be written in the regions indicated by the sixth, eighth, twelfth, fifteenth, sixteenth, and eighteenth indices INDEX5, INDEX7, INDEX11, INDEX14, INDEX15, and INDEX17, the sixth, eighth, twelfth, fifteenth, sixteenth, and eighteenth indices INDEX5, INDEX7, INDEX11, INDEX14, INDEX15, and INDEX17 may be classified as empty indices. In the write index FIFO memory, the index information on the sixth, eighth, twelfth, fifteenth, sixteenth, and eighteenth indices INDEX5, INDEX7, INDEX11, INDEX14, INDEX15, and INDEX17 may be newly stored and updated. Based on the index information on the sixth, eighth, twelfth, fifteenth, sixteenth, and eighteenth indices INDEX5, INDEX7, INDEX11, INDEX14, INDEX15, and INDEX17 stored in the write index FIFO memory, the write controller may store new packing data in the regions corresponding to the sixth, eighth, twelfth, fifteenth, sixteenth, and eighteenth indices INDEX5, INDEX7, INDEX11, INDEX14, INDEX15, and INDEX17. Because the scan conversion controller 1000 according to embodiments of the inventive concept prioritize output of image data for the channel on which image data input has been completed, the memory 1400 may be efficiently used.

At this time, the index information on the sixth, eighth, twelfth, fifteenth, sixteenth, and eighteenth indices INDEX5, INDEX7, INDEX11, INDEX14, INDEX15, and INDEX17 stored in the third channel index FIFO memory 1320_3 of FIG. 10 may be deleted.

FIGS. 12A to 12C are diagrams illustrating index results output according to a scan operation mode of image data according to some embodiments of the inventive concept.

FIG. 12A is a diagram illustrating indices to which first packing data ctx0 is allocated by line according to an example. For convenience, description is given based on the first packing data ctx0. However, it should be noted that embodiments of the inventive concept may be equally applied to a plurality of packing data items.

Referring to FIG. 12A, line data corresponding to a first line L0 included in the first packing data ctx0 may be allocated to the first index INDEX0, the fourteenth index INDEX13, the seventeenth index INDEX16, and the twentieth index INDEX19. Line data corresponding to a second line L1 included in the first packing data ctx0 may be allocated to the fourth index INDEX3, the tenth index INDEX9, the twelfth index INDEX11, and the 31st index INDEX30. Line data corresponding to a third line L2 included in the first packing data ctx0 may be allocated to the sixth index INDEX5, the eighth index INDEX7, the nineteenth index INDEX18, and the 31st index INDEX30. Line data corresponding to a fourth line L3 included in the first packing data ctx0 may be allocated to the sixteenth index INDEX15, the 28th index INDEX27, the 33rd index INDEX32, and the 34th index INDEX33.

FIGS. 12B and 12C are diagrams illustrating an index output for data read may be determined differently according to a scan operation mode by using index information items allocated according to an example of FIG. 12A.

Referring to FIG. 12B, an example in which index information items allocated according to the example of FIG. 12A are arranged by line is illustrated. Referring to FIG. 12C, a table is illustrated to explain a method of reading an index when the scan operation mode is determined to be a raster scan mode and when the scan operation mode is determined to be a tile scan mode.

According to an example, when the scan operation mode is the raster scan mode, the scan method may correspond to T2R. When the scan operation mode is the raster scan mode, an amount corresponding to an entire width is read from first line data, and then next line data may be sequentially read. Referring to FIGS. 12B and 12C, when the scan operation mode is the raster scan mode, the indices 0, 13, 16, and 19 corresponding to the entire width may be output from the first line L0, and the indices 3, 9, 11, and 22 corresponding to the entire width may be output from the second line L1. Then, the indices 5, 7, 18, and 30 corresponding to the entire width may be output from the third line L2, and the indices 15, 27, 32, and 33 corresponding to the entire width may be output from the fourth line L3.

According to an example, when the scan operation mode is the tile scan mode, the scan method may correspond to R2T. When the scan operation mode is the tile scan mode, output data may vary according to a size of a tile region to be scanned. In the tile scan mode, the first line L0, the second line L1, the third line L2, and the fourth line L3 may be sequentially scanned for as much as a tile width of a corresponding tile region and may be sequentially scanned up to a line corresponding to a tile height of the tile region.

According to an example, it is assumed that the size of the tile region to be scanned is 64×4. At this time, it is assumed that the number of data items stored in one index is 64. Referring to FIG. 12B, when the size of the tile region to be scanned is 64×4, a corresponding tile region is illustrated. When the tile region is 64×4, the first line L0, the second line L1, the third line L2, and the fourth line L3 may be sequentially read for as much as the tile width. At this time, because the height of the tile region is 4, the first line L0, the second line L1, the third line L2, and the fourth line L3 may be sequentially read. Accordingly, the indices may be output in the order of the indices 0, 3, 5, and 15 corresponding to a first tile region, the indices 13, 9, 7, and 27 corresponding to a second tile region, the indices 16, 11, 18, and 32 corresponding to a third tile region, and the indices 19, 22, 30, and 33 corresponding to a fourth tile region.

According to an example, it is assumed that the size of the tile region to be scanned is 128×4. At this time, it is assumed that the number of data items stored in one index is 64. Referring to FIG. 12B, when the size of the tile region to be scanned is 128×4, a corresponding tile region is illustrated. When the tile region is 128×4, the first line L0, the second line L1, the third line L2, and the fourth line L3 may be sequentially read as much as the tile width. At this time, because the height of the tile region is 4, the first line L0, the second line L1, the third line L2, and the fourth line L3 may be sequentially read. Accordingly, the indices may be output in the order of the indices 0, 13, 3, 9, 5, 7, 15, and 27 corresponding to a first tile region and the indices 16, 19, 11, 22, 18, 30, 32, and 33 corresponding to a second tile region.

In this way, the packing data items may be stored with indices allocated by line and channel, and the scan conversion controller may control a data reading method to suit the data method to be processed by the image processing circuit. The scan conversion controller may output the indices allocated and stored by channel and line and may transmit the indices to the read controller so that data may be read by the raster scan method or the tile scan method. According to embodiments of the inventive concept, conversion into T2R or R2T may be easily performed according to a form in which the indices corresponding to the memory are output after the indices corresponding to the memory are allocated.

FIG. 13 is a diagram illustrating a method of outputting a plurality of multi-context data items when the plurality of multi-context data items having different forms are input according to embodiments of the inventive concept.

Referring to FIG. 13, first multi-context data ctx0, second multi-context data ctx1, and third multi-context data ctx2 are randomly input. At this time, it is assumed that the first multi-context data ctx0 and the second multi-context data ctx1 are input as line data and may be output only after being input up to the fourth line L3. The third multi-context data ctx2 may be in a bypass form, that is, in a data form that may be output immediately without being input up to any line. According to an example, the first multi-context data ctx0 and the second multi-context data ctx1 may be input by the tile scan method, and the third multi-context data ctx2 may be input by the raster scan method. When the multi-context data items are randomly input, write/read points of the multi-context data items are different, so that bypass is also required for storage rather than immediate output. According to embodiments of the inventive concept, “multi-context” or “multi-context data” may mean a plurality of image data items input from different imaging devices.

Referring to FIG. 13, first line data ctx0 L0 of the first multi-context data ctx0 is input, and third line data ctx1 L2 of the second multi-context data ctx1 is subsequently input. Then, the third multi-context data ctx2 is input in a bypass form ctx2 Bypass. At this time, the first multi-context data ctx0 and the second multi-context data ctx1 may not be output because all line data items are not yet input. However, because the third multi-context data ctx2 is input in the bypass form, the third multi-context data ctx2 may be output in real time.

Then, the second line data ctx0 L1 of the first multi-context data ctx0 and the third line data ctx0 L2 of the first multi-context data ctx0 are sequentially input, and the fourth line data ctx1 L3 of the second multi-context data ctx1 is input. Accordingly, all line data items of the second multi-context data ctx1 may be input and immediately output as ctx1 tile. Data in a bypass form of the third multi-context data ctx2 input next may be output immediately after the output of ctx1 tile of all the line data items of the second multi-context data ctx1. In addition, through the input of the fourth line data ctx0 L3 of the first multi-context data ctx0, all line data items of the first multi-context data ctx0 may be input and immediately output as ctx0 L3.

Referring to FIG. 13, although multi-context data items in different forms, that is, input in different scan methods, are input in a random order, data in a bypass form may be immediately output, and multi-context data to which all line data is input may also be immediately output.

Referring to FIG. 13, data in a bypass form may be input, and different sizes and different lines may be input by multi-context data. At this time, because outputs may be sequentially performed, it is possible to perform a role of a throttle buffer, and an inactive buffer included in a DMA may also be reduced.

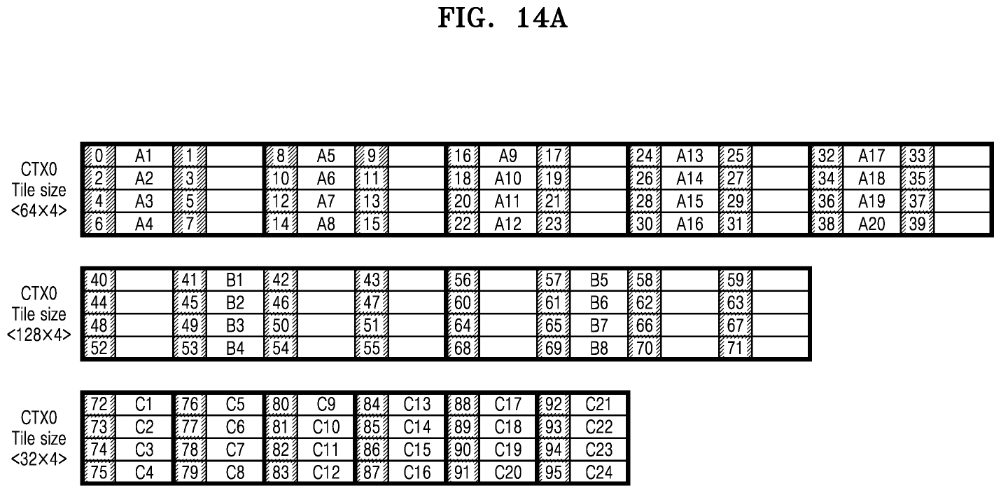

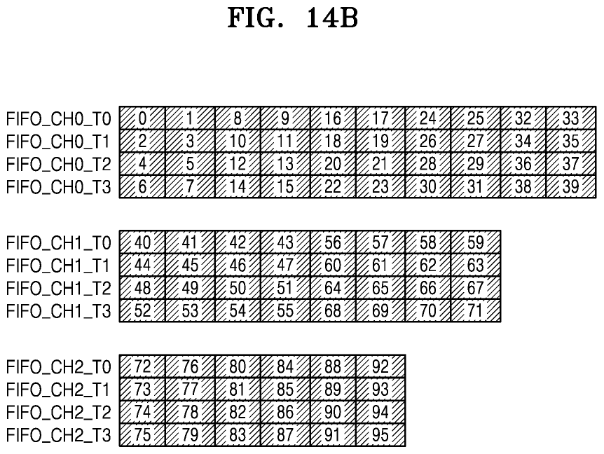

FIGS. 14A and 14B are diagrams illustrating an example of storing multi-context data items in a channel index FIFO and reading the multi-context data items in an example method according to an embodiment of the inventive concept.

Referring to FIG. 14A, multi-context data items having three different sizes are provided. Referring to FIG. 14A, first multi-context data CTX0, second multi-context data CTX1, and third multi-context data CTX2 are input. The first multi-context data CTX0, the second multi-context data CTX1, and the third multi-context data CTX2 may have different tile regions. The first multi-context data CTX0 may have a tile region size of 64×4, the second multi-context data CTX1 may have a tile region size of 128×4, and the third multi-context data CTX2 may have a tile region size of 32×4. Indices may be allocated to the first multi-context data CTX0, the second multi-context data CTX1, and the third multi-context data CTX2 by channel and line. In an example of FIG. 14A, 32 data items may be allocated to one index. Indices are allocated to tile regions included in each of the first multi-context data CTX0, the second multi-context data CTX1, and the third multi-context data CTX2 illustrated in FIG. 14A, and the tile regions included in each of the first multi-context data CTX0, the second multi-context data CTX1, and the third multi-context data CTX2 may be labeled by tile region size. According to an example, the second multi-context data CTX1 may have two tile regions of 128×4, the left tile region of the two tile regions may be labeled as B1, B2, B3, and B4 by line, and the right tile region of the two tile regions may be labeled as B5, B6, B7, and B8 by line.

The allocated indices may be stored in the channel index FIFO memory by channel and line. Referring to FIG. 14B, index information corresponding to the first multi-context data CTX0 may be stored in the first channel index FIFO memory 1320_1 by lines FIFO_CH0_T0, FIFO_CH0_T1, FIFO_CH0_T2, and FIFO_CH0_T3. Index information corresponding to the second multi-context data CTX1 may be stored in the second channel index FIFO memory 1320_2 by lines FIFO_CH1_T0, FIFO_CH1_T1, FIFO_CH1_T2, and FIFO_CH1_T3. Index information corresponding to the third multi-context data CTX2 may be stored in the third channel index FIFO memory 1320_3 by lines FIFO_CH2_T0, FIFO_CH2_T1, FIFO_CH2_T2, and FIFO_CH2_T3.

Through information stored in the first channel index FIFO memory, the second channel index FIFO memory, and the third channel index FIFO memory, an index output may be determined differently according to each scan mode.

According to an example, when data is to be output in the raster scan mode through information stored in the first channel index FIFO memory, the data may be read by line as much as the entire width. Output results may be (0, 1, 8, 9, 16, 17, 24, 25, 32, and 33), (2, 3, 10, 11, 18, 19, 26, 27, 34, and 35), . . . . According to an example, a size of data read by index may be optimized and selected according to an image size, a tile region size, the number of channels, and bits.

According to an example, when data is to be output in the tile scan mode through the information stored in the first channel index FIFO memory, the data is read for as much as a width of a tile in a first line and then, the data may be read in a next line. When tile region size is 64×4, output results may be (0, 1, 2, 3, 4, 5, 6, and 7) and (8, 9, 10, 11, 12, 13, 14, and 15).

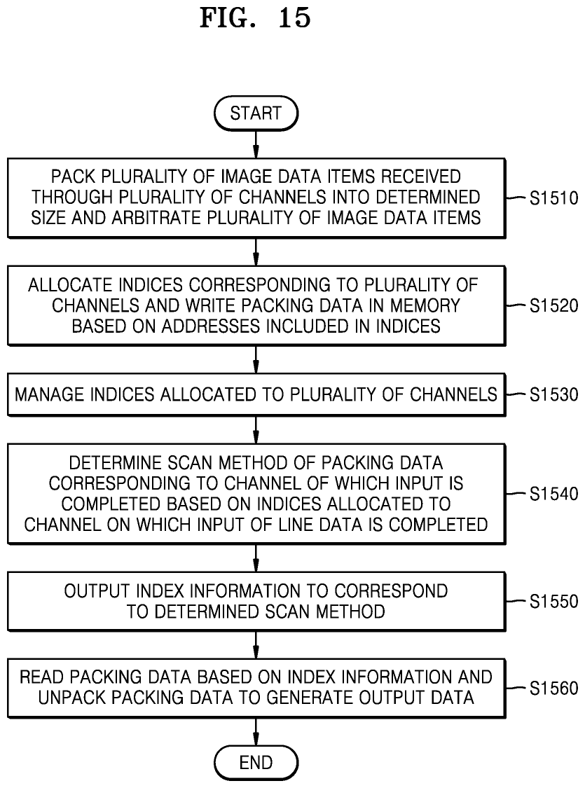

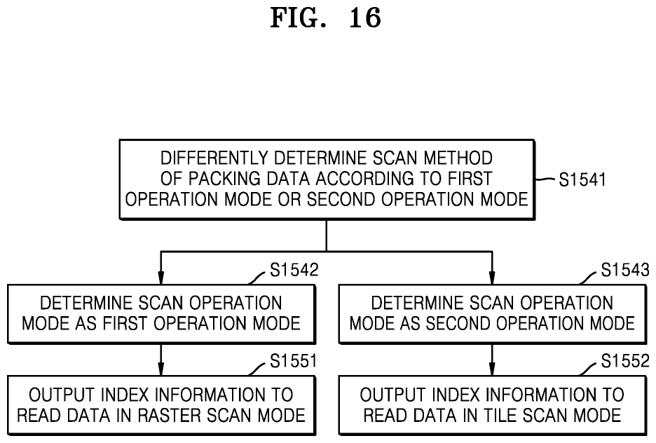

FIGS. 15 to 16 are flowcharts illustrating a method of operating an image processing circuit according to an embodiment of the inventive concept. Operations S1541, S1542, and S1543 of FIG. 16 may be an example of operation S1540 of FIG. 15, and operations S1551 and S1552 may be an example of operation S1550 of FIG. 15.

Referring to FIGS. 15 to 16, the image processing circuit may pack line data received through each of a plurality of channels into a predetermined data size to generate packed data in operation S1510. At this time, the data size may be determined according to the number of channels connected to a scan conversion controller and the maximum number of bits received during one clock signal cycle in different line data items received from the plurality of channels. In addition, the data size may be determined according to a pixel per cycle (PPC) of each of the plurality of channels.

In an embodiment, the image processing circuit may receive first line data from a first image sensor through a first channel among the plurality of channels, and may receive second line data from a second image sensor through a second channel among the plurality of channels. In other embodiments, the image processing circuit may receive the first line data from an image sensor through the first channel among the plurality of channels, and may receive the second line data from a memory access controller through the second channel among the plurality of channels.

In operation S1520, the image processing circuit may allocate indices corresponding to each of the plurality of channels and may write packing data to the memory included in the image processing circuit based on the addresses included in the indices. Each of the addresses may correspond to packing data, and the data size of the index may be a multiple (for example, 8 times) of the data size of the packing data. Therefore, one index may correspond to a plurality of addresses.

The image processing circuit may manage indices allocated to each of the plurality of channels in operation S1530. For example, the image processing circuit may include first memory (for example, the first channel index FIFO memory 1320_1 of FIG. 5B) for managing first indices allocated to a first channel among the plurality of channels and second memory (for example, the second channel index FIFO memory 1320_2 of FIG. 5B) for managing second indices allocated to a second channel among the plurality of channels.

In operation S1540, the image processing circuit may determine a scanning method of packing data corresponding to a channel on which input of line data is completed based on the indices allocated to the channel on which input of line data is completed. According to one example, it may be determined whether to scan packing data corresponding to the channel on which input of line data is completed by the raster scan method or the tile scan method. According to an example, the scan method may be determined according to the operation of the image processing circuit or may be determined in advance.

In operation S1541, the image processing circuit may determine a method of scanning packing data according to the first operation mode or the second operation mode.

In operation S1550, the image processing circuit may output index information corresponding to the determined scan method. When the scan operation mode is determined as the first operation mode in operation S1542, index information may be output to read data in the raster scan mode in operation S1551. In operation S1551, according to the first operation mode, index information may be output so that indices allocated to the channel of which input is completed may be sequentially read from the first line as much as the entire width of the channel index FIFO memory where the indices are stored. When the scan operation mode is determined as the second operation mode in operation S1543, index information may be output to read data in the tile scan mode in operation S1552. In operation S1552, according to the second operation mode, index information may be output by sequentially reading indices allocated to the channel of which input is completed from the first line as much as a width of a set tile region of the channel index FIFO memory where the indices are stored as many lines as the number corresponding to a height of the set tile region.

In operation S1560, the image processing circuit may read packing data based on the output index information and unpack the packing data to generate output data. For example, when input of line data from the first channel among the plurality of channels is completed, packing data corresponding to the first channel may be read from memory based on the indices allocated to the first channel. The image processing circuit may generate output data by unpacking read data to have the same data form as the line data.

The image processing circuit according to embodiments of the inventive concept may be applied to various technological fields such as mobile, XR, automotive, and/or CIS. The image processing circuit according to embodiments of the inventive concept may simultaneously process a plurality of images received from a plurality of sensors, and may maximize memory efficiency and secure area efficiency by appropriately converting the scan method of the plurality of images. The image processing circuit according to embodiments of the inventive concept may check the empty space of the SRAM memory device and may convert the scan method through FIFO memory indexing to easily sort stored data.

While embodiments of the inventive concept have been particularly shown and described with reference to embodiments thereof, it will be understood that various changes in form and details may be made therein without departing from the spirit and scope of the following claims.

What is claimed is:

1. An image processing circuit comprising:
a scan conversion controller configured to receive images from a plurality of channels connected to a plurality of imaging devices and to generate output data; and
an image signal processor configured to receive and process the output data from the scan conversion controller, wherein the scan conversion controller is configured to determine a scan method for generating the output data according to a first operation mode or a second operation mode.

2. The image processing circuit of claim 1, wherein the scan conversion controller configured to scan the output data using a raster scan method in the first operation mode and in configured to scan the output data using a tile scan method in the second operation mode.

3. The image processing circuit of claim 2, wherein the scan conversion controller comprises:
a memory configured to store packing data items obtained by packing images received from each of the plurality of channels according to an index allocated to each of the plurality of channels; and
a plurality of channel index memories configured to store index information of the memory in which the packing data items are stored according to the plurality of channels.

4. The image processing circuit of claim 3, wherein the scan conversion controller outputs index information for a read operation based on information stored in the channel index memory corresponding to a channel of packing data of which input is completed first among the packing data items.

5. The image processing circuit of claim 4, wherein, in the first operation mode, the scan conversion controller outputs index information to sequentially read indices stored in respective ones of the plurality of channel index memories from a first line for as much as a total width of the channel index memory.

6. The image processing circuit of claim 4, wherein, in the second operation mode, the scan conversion controller outputs index information by sequentially reading indices stored in respective ones of the plurality of channel index memories from a first line for as much as a width of a set tile region for as many lines as a number corresponding to a height of the set tile region.

7. The image processing circuit of claim 2, wherein the scan conversion controller selects the first operation mode or the second operation mode to scan images received from each of the plurality of channels.

8. The image processing circuit of claim 2, wherein the scan conversion controller is configured to first output the image that is received first from among the images received from the plurality of channels.

9. The image processing circuit of claim 3, wherein the memory comprises static random access memory (SRAM), and
wherein each of the plurality of channel index memories operates in a first-in first-out (FIFO) method.

10. A scan conversion controller comprising:
a first data packing circuit configured to receive first line data from a first channel and to pack the first line data into a predetermined data size to generate first packing data;
a second data packing circuit configured to receive second line data from a second channel and to pack the second line data into a predetermined data size to generate second packing data;
an arbitration circuit configured to receive the first packing data and the second packing data and to sequentially output the first packing data and the second packing data;
a memory configured to store the first packing data and the second packing data;
a line index controller configured to manage a first index for a first region in which the first packing data is stored in the memory, and a second index for a second region in which the second packing data is stored in the memory, and to determine a scan method of the first packing data and the second packing data allocated to the first index and the second index, respectively;
a write controller configured to control a write operation of the memory;
a read controller configured to control a read operation of the memory; and
an unpacking circuit configured to generate output data by unpacking read data output from the read controller.

11. The scan conversion controller of claim 10, wherein the line index controller comprises:
a first channel index memory in which index information of the first region of the memory is stored;
a second channel index memory in which index information of the second region of the memory is stored; and
an index controller configured to obtain index information from the first channel index memory and the second channel index memory, to determine a scan method of the obtained index information, and to output the obtained index information for a read operation.

12. The scan conversion controller of claim 11, wherein the index controller is further configured to output the obtained index information for reading the first or second channel index memory of a channel in which packing data of which input is completed first among the first channel index memory and the second channel index memory is stored.

13. The scan conversion controller of claim 12, wherein, when a scan method of the obtained index information is a raster scan method, the index controller is configured to output index information so that channel index memory of the channel in which packing data of which input is completed first is stored is sequentially read from a first line for as much as an entire width of the channel index memory.

14. The scan conversion controller of claim 12, wherein, when a scan method of the obtained index information is a tile scan method, the index controller is configured to output index information by sequentially reading channel index memory of the channel in which packing data of which input is completed first from a first line for as much as a width of a set tile region of the channel index memory for as many lines as a number corresponding to a height of a set tile region.

15. The scan conversion controller of claim 12, when it is not required to convert a scan method of the obtained index information, wherein the index controller is configured to immediately output the obtained index information when the packing data of which input is completed first does not exist and output the obtained index information after outputting the packing data when the packing data of which input is completed first exists.

16. The scan conversion controller of claim 11, wherein the memory is static random access memory (SRAM), and
wherein the first channel index memory and the second channel index memory operate in a first-in first-out (FIFO) method.

17. A method of operating an image processing circuit including a scan conversion controller including an internal memory, the method comprising:
packing line data received through each of a plurality of channels into a predetermined data size to generate packing data;
allocating indices corresponding to each of the plurality of channels and writing the packing data to the internal memory based on addresses included in the allocated indices;
managing indices allocated to each of the plurality of channels;
determining a scan method of the packing data corresponding to the channel of which input is completed based on indices allocated to one of the plurality of channels to which input of line data is completed;
outputting index information corresponding to the determined scan method;
reading the packing data from the internal memory based on the index information; and
unpacking read data read from the internal memory and generating output data.

18. The method of claim 17, wherein the determining of the scan method of the packing data comprises determining a scan method for generating the packing data according to a first operation mode or a second operation mode.

19. The method of claim 18, wherein the outputting of the index information corresponding to the determined scan method comprises outputting the index information to sequentially read indices allocated to the channel of which input is completed according to the first operation mode from a first line for as much as a total width of channel index memory where the indices are stored.

20. The method of claim 18, wherein the outputting of the index information corresponding to the determined scan method comprises outputting the index information by sequentially reading indices allocated to the channel of which input is completed according to the second operation mode from a first line for as much as a width of a set tile region of channel index memory where the indices are stored for as many lines as a number corresponding to a height of a set tile region.
